(19) United States
(12) Patent Application Publication
(10) Pub. No.: US 2016/0266473 A1
(43) Pub. Date: Sep. 15, 2016

(54) IMAGING DEVICE HOLDER

(71) Applicants: Russell N. Knight, Anchorage, AK (US); Nicholas P. Savander, Los Angeles, CA (US)

(72) Inventors: Russell N. Knight, Anchorage, AK (US); Nicholas P. Savander, Los Angeles, CA (US)

(21) Appl. No.: 15/069,406

(22) Filed: Mar. 14, 2016

Related U.S. Application Data
(60) Provisional application No. 62/132,761, filed on Mar. 13, 2015.

(51) Int. Cl. G03B 17/08; G03B 17/56

(52) U.S. Cl. CPC G03B 17/08; G03B 17/561

(57) ABSTRACT

An imaging device holder is described herein. The imaging device holder has, in an embodiment, a body defining a recess configured to at least partially receive an imaging device, and the body has a buoyant characteristic. A tail is coupled to the body. The tail is configured to be changed between a plurality of tail positions or tail shapes.

### CROSS-REFERENCE TO RELATED APPLICATION

This application is a non-provisional of, and claims the benefit and priority of, U.S. Provisional Patent Application No. 62/132,761, filed on Mar. 13, 2015. The entire contents of such application are hereby incorporated by reference.

### BACKGROUND

It has become popular to use cameras in a wide range of environments, including water environments. There are conventional cases for cameras. The conventional cases protect the cameras against water, are mountable to floating objects and can, alternatively, be held by photographers in the water. These conventional cases can include flotation devices, such as in the form of a handle or a mounted square, to prevent the camera from sinking in the event the camera separates from the mounting object or the user. However, these flotation devices merely prevent the camera from sinking and typically rise to the surface, while the camera dangles upside down in the water from the flotation device. Thus, the conventional case does not enable depth-controlled or angle-controlled camera shots while the camera is in the water. Furthermore, the conventional case lacks versatility for uses in water and outside of water.

The foregoing background describes some, but not necessarily all, of the problems, disadvantages and shortcomings related to imaging in water, in extreme environments and during activities.

### SUMMARY

In an embodiment, an imaging device holder is described. The imaging device holder has a body defining a recess configured to at least partially receive an imaging device, the body comprising a buoyant characteristic. A tail is coupled to the body. The tail includes a first tail segment non-pivotally coupled to the body and a second tail segment coupled to the first tail segment. The second tail segment is movable relative to the first tail segment. A horizontal axis extends through the imaging device holder and the horizontal axis is positionable relative to a plane of a liquid surface upon which the holder is placed. The second tail segment tail segment is configured to be moved relative to the horizontal axis to aim a shooting direction of the imaging device.

In another embodiment, an imaging device holder is described. The imaging device holder has a body including an imaging device coupler and a buoyant characteristic. A tail is coupled to the body. The tail is configured to be changed from a first shape to a second shape in response to a force greater than a shape deformation force.

In yet another embodiment, an imaging device holder is described. The imaging device holder includes a body defining a recess configured to at least partially receive an imaging device. The body has a buoyant characteristic. A tail is coupled to the body. The tail includes a bendable core and a coating covering the core.

Additional features and advantages of the present disclosure are described in, and will be apparent from, the following Brief Description of the Drawings and Detailed Description.

### BRIEF DESCRIPTION OF THE DRAWINGS

FIG. 1 is a top isometric view of an embodiment of an imaging device holder.

FIG. 2 is a bottom isometric view of the imaging device holder of FIG. 1.

FIG. 3 is front view of the imaging device holder of FIG. 1, illustrating a camera housed within the image device holder.

FIG. 4 is a rear view of the imaging device holder of FIG. 1.

FIG. 5 is a right side view of the imaging device holder of FIG. 1, illustrating various tail positions.

FIG. 6A is a schematic diagram of an embodiment of the imaging device holder in water with the shooting direction extending parallel to the water surface.

FIG. 6B is a schematic diagram of an embodiment of the imaging device holder in water with the shooting direction extending at an upward angle relative to the water surface.

FIG. 6C is a schematic diagram of an embodiment of the imaging device holder in water with the shooting direction extending at a downward angle relative to the water surface.

FIG. 7 is a left side view of the imaging device holder of FIG. 1.

FIG. 8 is a top view of the imaging device holder of FIG. 1.

FIG. 9 is a bottom view of the imaging device holder of FIG. 1.

FIG. 10 is a side isometric view of an embodiment of the body of the imaging device holder of FIG. 1.

FIG. 11 is a rear isometric view of an embodiment of the body of FIG. 10.

FIG. 12 is a fragmentary isometric view of the body and tail of the imaging device holder of FIG. 1, illustrating the coupling of the tail to the body.

FIG. 13 is a cross-sectional isometric view of an embodiment of the imaging device holder of FIG. 1.

FIG. 14 is a front cut-away view of an embodiment of the imaging device holder of FIG. 1, illustrating the body having the face removed to expose an example of a camera held by the image device holder.

### DETAILED DESCRIPTION

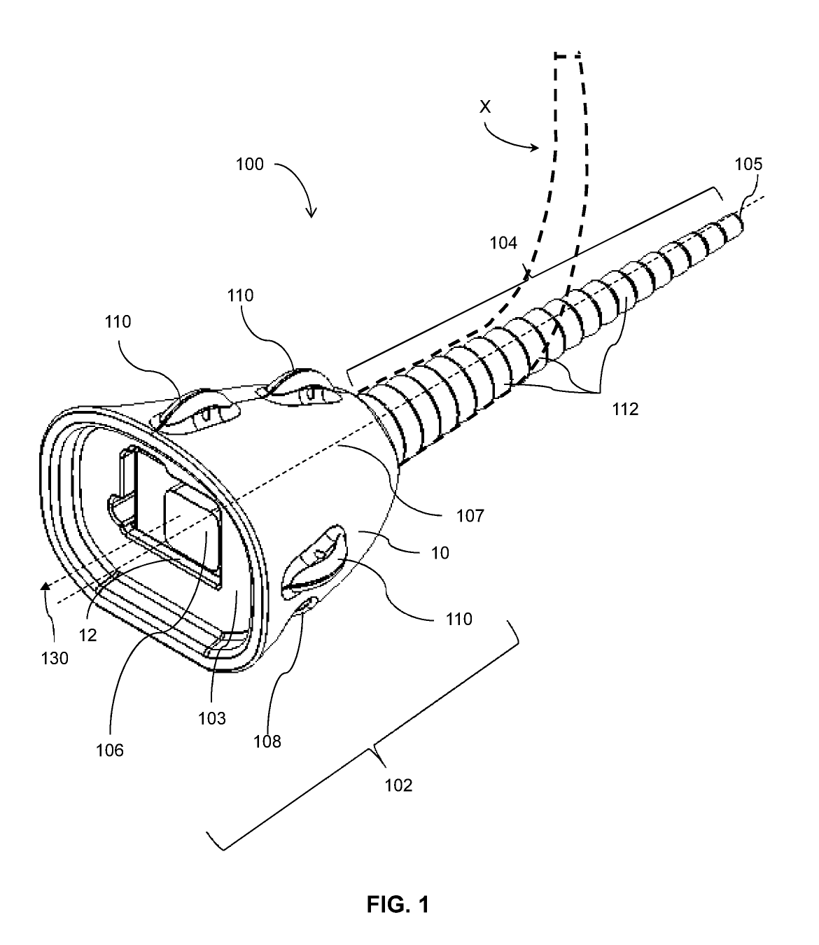

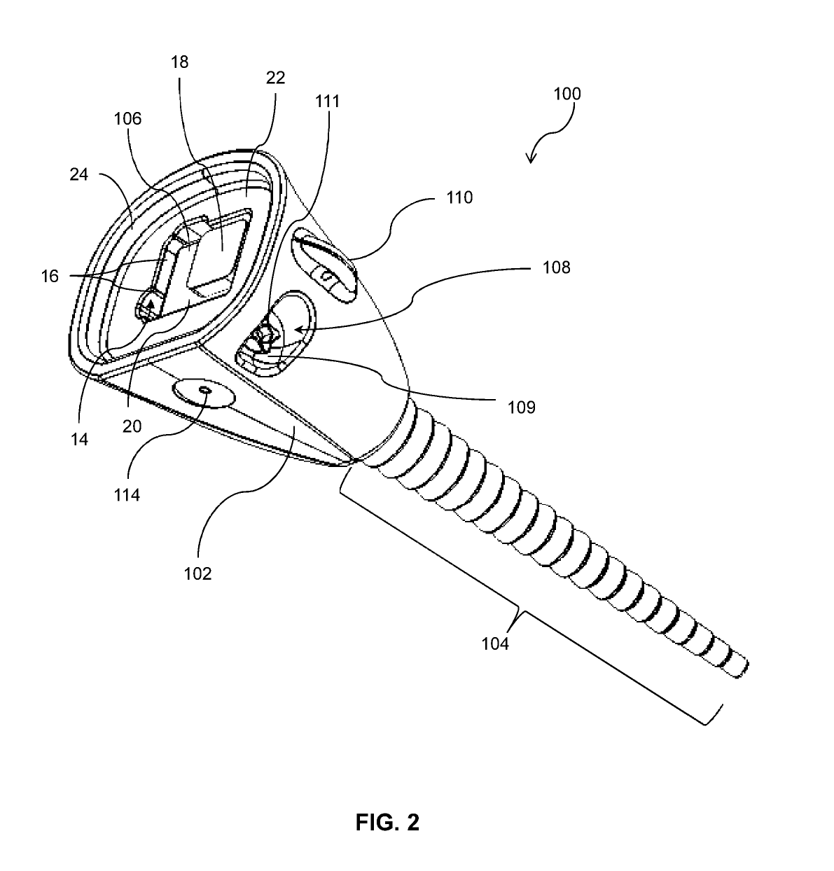

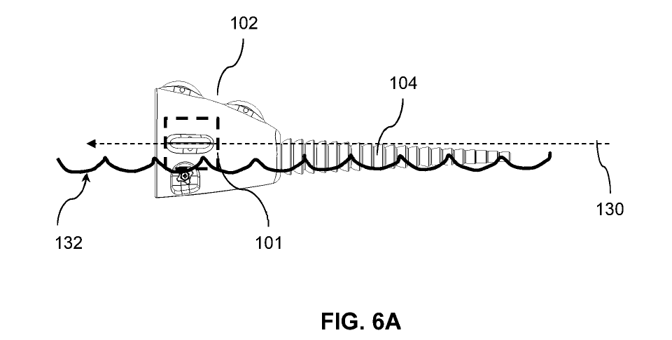

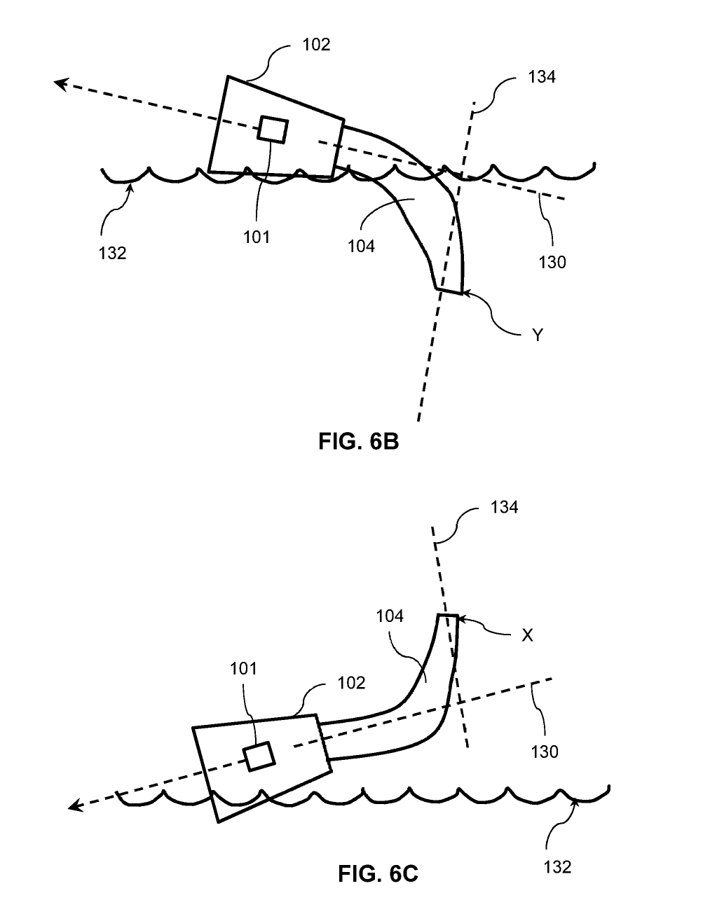

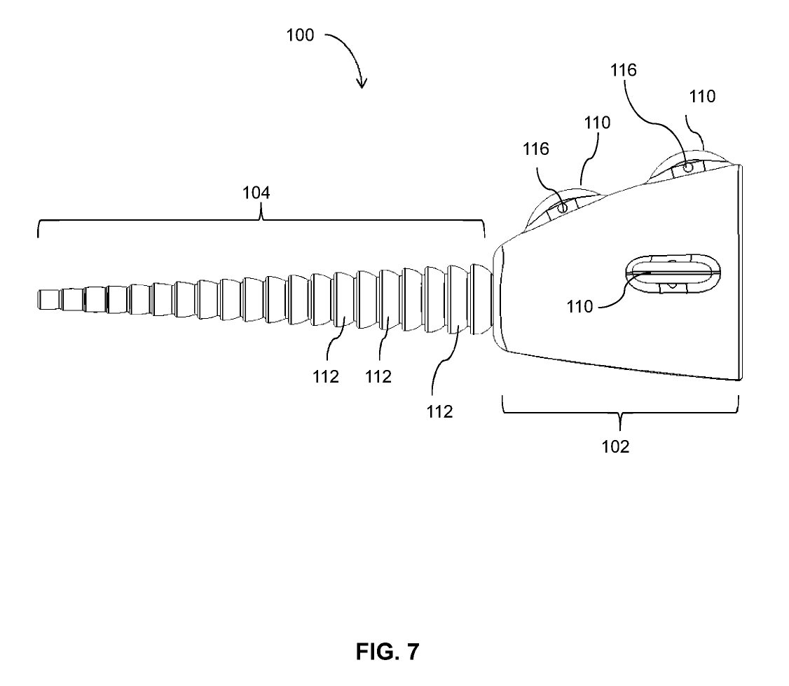

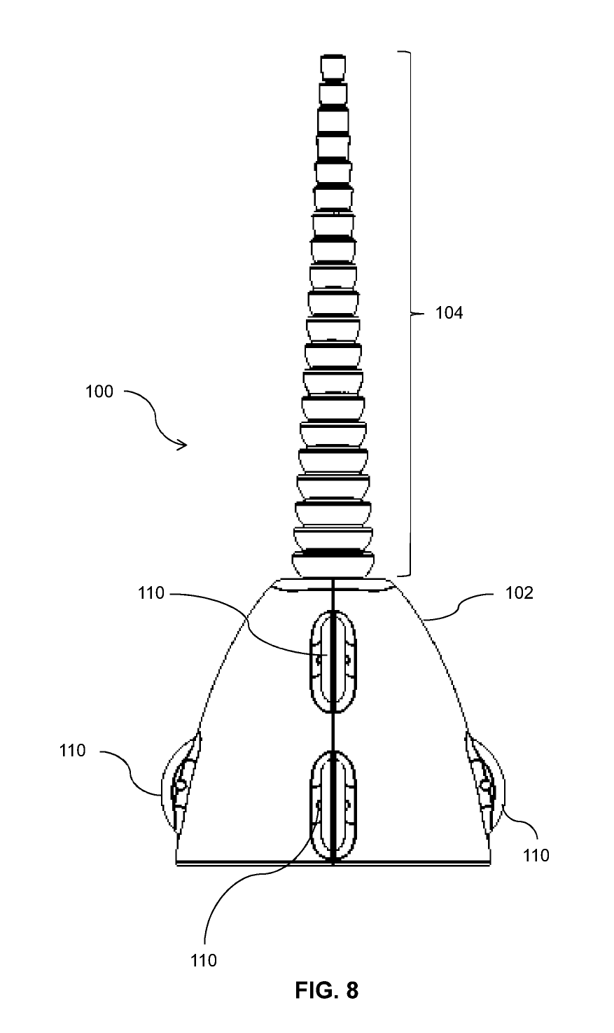

As illustrated in FIGS. 1-2, in an embodiment, the imaging device case, carrier, accessory, attachment or holder 100 has: (a) a housing or body 102; and (b) a float position adjuster or tail 104. The housing or body 102 has: (a) a partially conical, exterior body wall 10, which defines an imaging device cavity or recess 106 configured to at least partially receive an imaging device 101 (FIGS. 6A-6C); (b) a panel or face 103 defining the perimeter 12 of the recess 106; (c) an imaging device coupler or coupling device 108 configured to mount or couple the imaging device 101 to body 102; and (d) a plurality of ears, mounts, couplers, or tabs 110 extending from the body wall 10 of the body 102.

The imaging device holder 100 is configured to hold an imaging device 101 (FIGS. 6A-6C). The imaging device 101 can be any suitable device, such as an audiovisual device, a video recorder, a smartphone, phone, or other communication device having a built-in camera or video recorder, a camcorder, a webcam, a still camera, a video camera, a digital camera operable to take photographs and record video, or any other suitable image-capturing device. For example, the imaging device 101 can be a handheld, portable, battery-powered action camera, designed to be worn, held, or used during action events in motion pictures or in athletic activities. In an embodiment, the imaging device 101 is water-resistant or waterproof. In another embodiment, the imaging device 101 is situated in its own water-resistant or waterproof shell or housing. In yet another embodiment, the imaging device 101 has a built-in radio frequency (RF) transceiver to enable a user to remotely control, and remotely communicate with, the imaging device 101 through a smartphone, any Internet-access device (e.g., a laptop or tablet computer) or other suitable controllers.

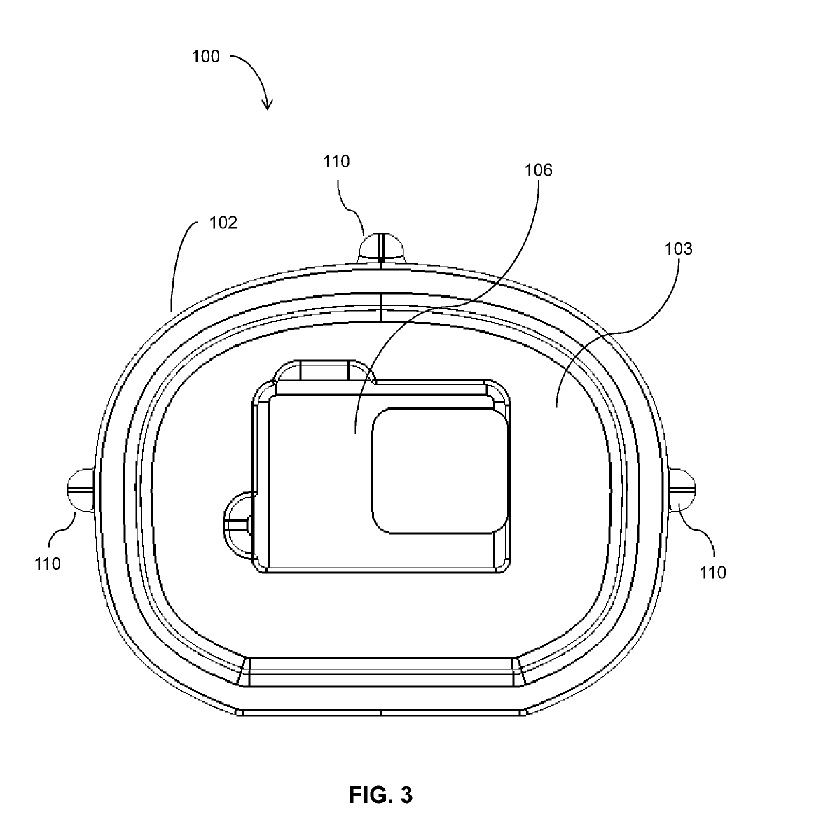

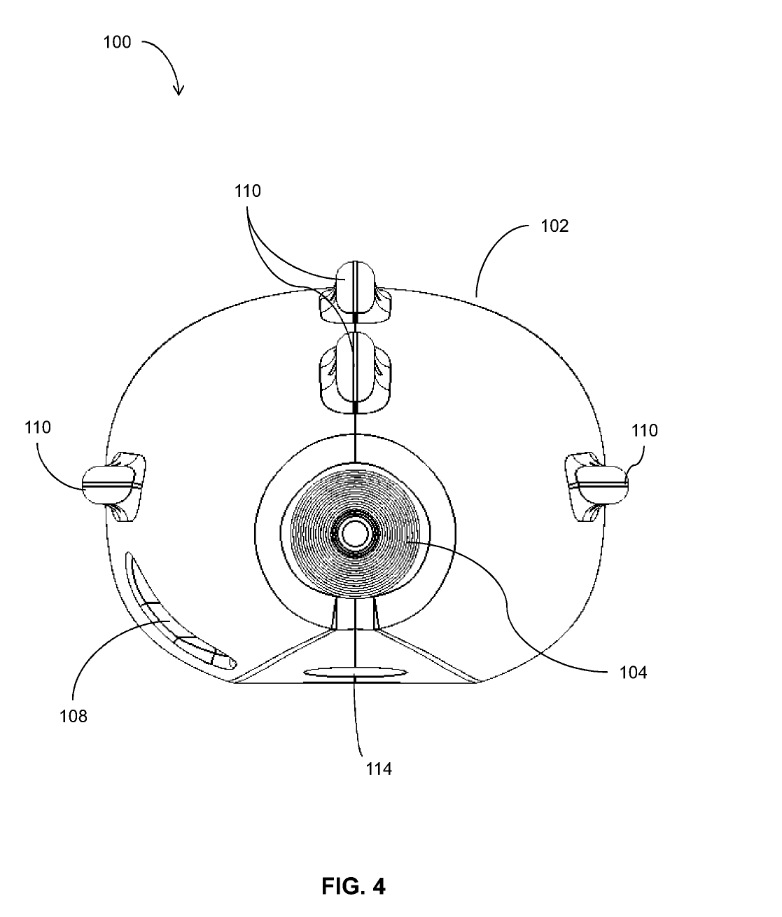

The recess 106 is configured to at least partially receive the imaging device 101. In an embodiment, the recess 106 can be configured to match, or mate with, the exact shape of a particular imaging device model. In another embodiment, the recess 106 can be configured to have a general shape for receiving a variety of different imaging device model shapes. In an embodiment, the recess 106 is configured to have a shape which conforms to the shape of the imaging device 101. For example, the recess 106 can have a stepped shape to correspond to a stepped shape of the imaging device 101. In the example illustrated in FIGS. 2-3, the body 102 has: (a) a retaining wall 14 configured to receive and surround the sides, top and bottom of the imaging device 101, wherein the retaining wall 14 has a plurality of different steps 16 to conform to the stepped or non-uniform geometry of the imaging device 101; and (b) one or more imaging device engagers, such as imaging device engager 18 configured to engage a stepped-down portion or recessed portion of the imaging device 101 to stabilize the imaging device 101.

Referring to FIG. 2, in an example of an embodiment, the user connects the imaging device 101 so that the back (not shown) of the imaging device 101 engages with the floor 20 and engager 18 within the recess 106. The front (not shown) of the imaging device 101, including its lens, is positioned within the lens protection recess 22 defined by the body extension or lip 24. Accordingly, when the imaging device holder 100 is dropped, the lip 24 can prevent objects from striking an scratching the lens of the imaging device 101.

In an embodiment, the housing or body 102 is formed of a flexible material designed to act as a shock absorber. Suitable examples of this flexible material include a foam material, such as foam rubber or a polyfoam. By acting as a shock absorber, the material of the body 102 protects the imaging device within the recess 106 from damage caused by drops, falls, collisions with objects and impact due to other external forces. In addition, by absorbing shocks, the inner surface 12 of the body 102 engages or cradles the imaging device to prevent the imaging device 101 from being jostled or vibrated, resulting in a smoother imaging. Further, this shock absorption protects the imaging device 101 from errors, such as corrupt files or inappropriate memory card ejection. In one embodiment, the body 102 has a relatively thick wall cross-section having an elastic property or spring property. In an embodiment, the body 102 contains or includes a plurality of shock absorbing elements, such as springs, biasing members, dampers, bubble-wrap substrate or a combination thereof.

In an embodiment, this material of the imaging device holder 100 has a float or buoyant characteristic such that the material is configured to float in water to enable the imaging device 101 to record imaging on, in or under water. In another embodiment, the material of the imaging device holder 100 does not have a float or buoyant characteristic. Rather, the body 102 has one or more air-filled cavities or pockets, including, but not limited to, any air pockets of recess 106. These air-filled cavities provide the imaging device holder 100 with a float or buoyant characteristic. Because of its buoyant property or characteristic, the imaging device holder 100 generates an upward buoyancy force when placed in water, causing the imaging device holder 100 to fully or partially float. It should be appreciated, however, that the imaging device holder 100 can be sunk or submerged beneath the water surface for under-water imaging, such as through the use of the weighted anchor 121 described below.

As described below, imaging device holder 100 is configured to float levelly at the surface 132 of the water (FIGS. 6A-6C) for capturing imagery, acting as a “water tripod.” An imaging device 101 mounted in the holder 100 sits level in the holder 100 while the holder 100 is being floated, wedged, propped, thrown, sunk, suspended above or below water, anchored underwater, handheld, or mounted to other accessories, even during vigorous activity such as aerial camera shooting. In an embodiment, the holder 100 can be a bright color to increase visibility. In another embodiment, the holder 100 can be of a subdued or camouflaged color to decrease visibility.

Referring to FIGS. 1-2, the coupler or coupling device 108 can be configured to extend through the body 102 to lock or secure the imaging device 101 in the recess 106 and lens protection recess 22. The coupling device 108 can include any suitable type of coupler or securing device. In one embodiment, as illustrated in FIG. 2, the coupling device 108 includes: (a) an access wall 109 which defines an access opening or port; and (b) a suitable fastener 111 configured to extend through the port and connect to the imaging device 101. For example, the coupling device 108 can include a fastener, including, but not limited to, a standoff, a bolt, or a screw. In an embodiment, the coupling device 108 can be a ¼-20 thread screw. The coupling device 108 can be received by the imaging device 101 in the recess 106. In an embodiment, the coupling device 108 is received by a female, threaded mount of the imaging device 101. In another example, the imaging device 101 includes a tripod mount which receives the coupling device 108 to lock or secure the imaging device 101 within the recess 106. The coupling device 108 locks the imaging device 101 in the recess 106 to prevent the imaging device 101 from falling out of the imaging device holder 100, especially during vigorous activity. In an embodiment, the imaging device holder 100 can be thrown from a building top or helicopter, for example, during video capture without damaging the imaging device 101.

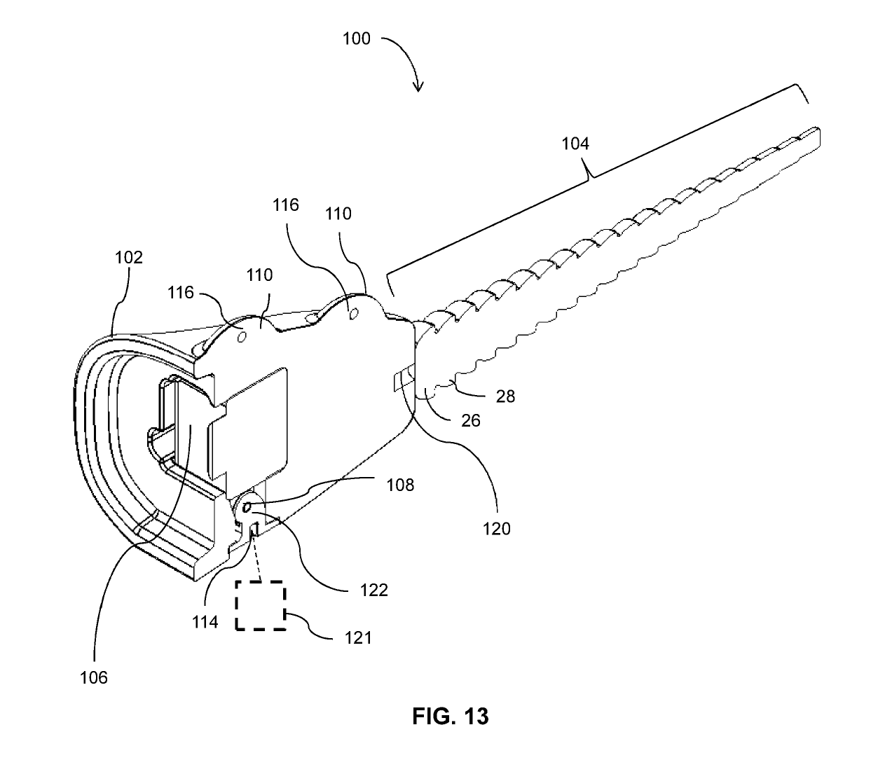

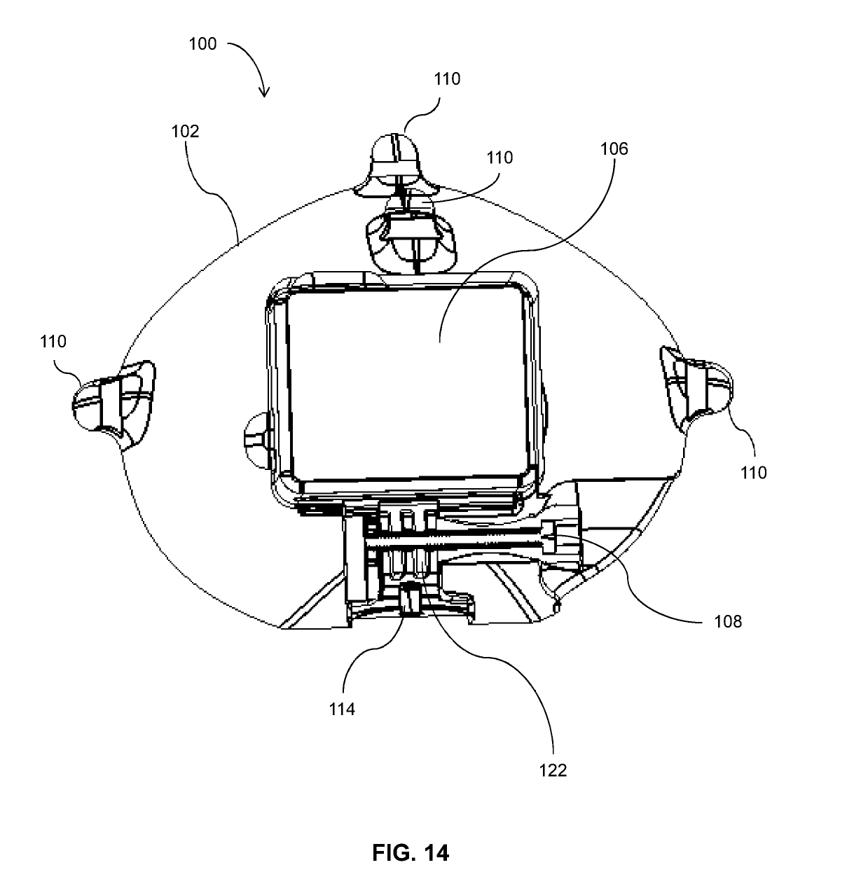

In an embodiment, illustrated in FIG. 2, the body 102 also defines a mounting recess 114. In an example, the mounting recess 114 can be a ¼-20 female mount for receiving a ¼-20 thread screw. The mounting recess 114 can provide access through the body 102 to a mount of the imaging device 101, such as a tripod mount coupled to the imaging device 101. As illustrated by FIG. 13, a tripod mount 122 can include the mounting recess 114 and the coupling device 108.

In an embodiment, the imaging device 101 attached to the device holder 100, can be mounted on a tripod stand (not shown) via the mounting recess 114. Depending upon the event, such tripod stand could be a land-type tripod suited for use on land or a water-type tripod suited for floating on water. In another embodiment, an accessory can be coupled to the imaging device 101 via the mounting recess 114.

In a further embodiment, a weighted anchor 121 (FIG. 13) can be coupled to the mounting recess 114 for underwater imaging. In this embodiment, the weight of the anchor counteracts the upward buoyancy force of the holder 100, holding the holder 100 at a particular depth beneath the water and allowing the imaging device 101 to record at that desired depth underwater. In one embodiment, the weighted anchor 121 includes a weight set of separable anchor weight members. Each weight member is associated with a different level of underwater depth. The user can connect the desired quantity of weight members to the imaging device (via a faster inserted through mounting recess 114) or directly to the body 102. By selecting the desired quantity of weight members, the user can selectively control the imaging depth of the imaging device 101 below the water surface. In an example, by running a cable from the imaging device 101 in the holder 100 along the anchor line to a Wi-Fi router mounted on a buoy, video can be streamed live from the imaging device 101 beneath the water surface to a device on or above the water surface.

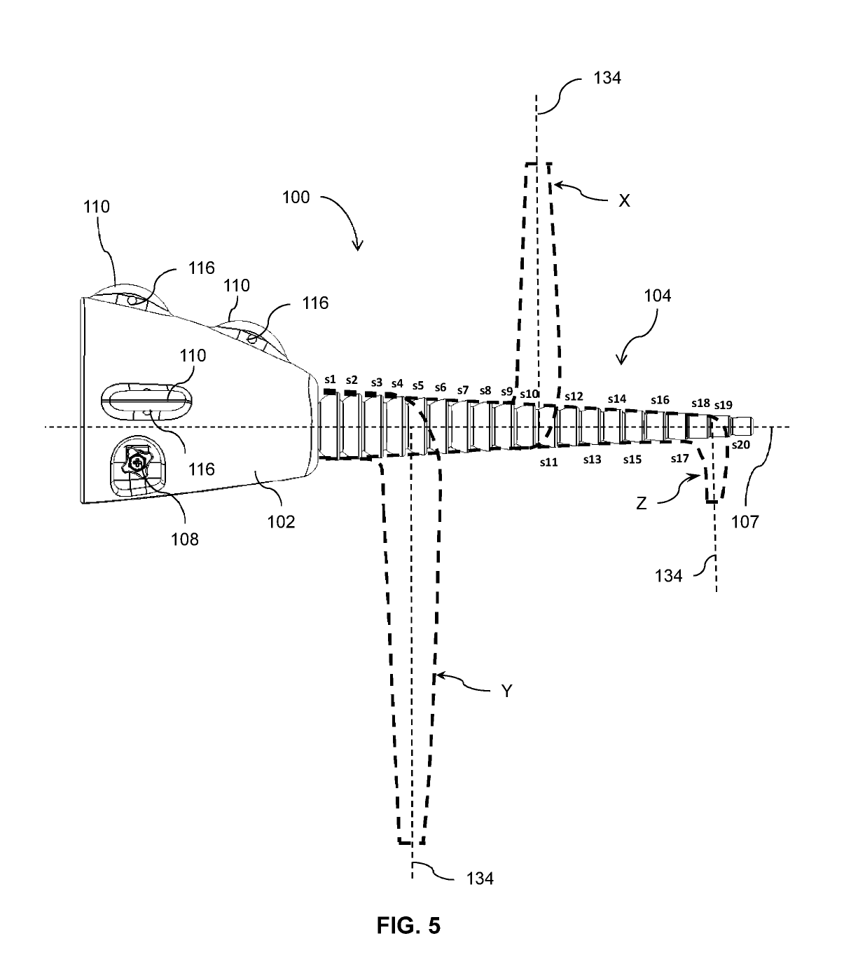

As illustrated by FIG. 5, a plurality of connectors or tabs 110 extend from the surface of the body 102. Each tab 110 defines a hole 116 through the tab 110. In an embodiment, the holes 116 extend through the tabs 110 parallel to a top surface of the body 102. These tabs 110 can serve as lacing guides for attaching a wire, rope or harness around the imaging device holder 100 to provide rope-based mounting and securing options. A rope, such as a para-cord, can be laced through the holes 116 of the tabs 110 to securely hold the enclosure. In an embodiment, a rope harness around the imaging device holder 100 can provide mounting and tethering options to assist in maintaining a desired angle of the imaging device holder 100 on the surface of water. In another embodiment, a rope harness laced through the tabs 110 can attach the imaging device holder 100 to a boat, an airplane or another vehicle. Also, in one embodiment, the array of connectors or tabs 110 serve to distribute the rope pulling forces about the body 102. This distribution of force decreases the likelihood that any single tab 110 will fail, crack, break or otherwise be damaged due to the rope forces caused by pulling, swinging, wind and other environmental factors.

The float position adjuster or tail 104 is configured to be transformed between a plurality of different shapes, such as the different tail shapes X, Y and Z illustrated in FIG. 5. Depending upon the embodiment, the tail 104 can include a plurality of separate, rigid elements connected through frictional joints, or the entire tail 104 can include a continuous wire or cable which is bendable and flexible. In an embodiment, the tail 104 is configured so that, the user must exert a threshold deformation force to deform the tail 104 from a first shape to a second shape. The tail 104 retains the second shape until the user changes the shape again by exerting the threshold deformation force again. In an embodiment, the threshold deformation force is greater than environmental forces, such as water waves and wind. Therefore, the tail 104 retains its shape despite the environmental forces. In an embodiment, the tail 104 has a flexible material formed from the same material as the body 102, or a different material. In an embodiment, the float position adjuster or tail 104 includes a bendable core coated by another material. For example, the flexible core can be a metal memory wire or cable coated by a foam material, or the tail 104 can include a flexible tube or sleeve constructed of a synthetic or natural rubber. In an embodiment, during operation, the tail 104 can be repositioned, such as by bending the tail 104, to control the viewing or shooting angle of the imaging device. In another embodiment, the tail can act as a handle or a mount for the imaging device holder 100. For example, the tail 104 can be wrapped around a mounting area, such as an oddly shaped mounting area unsuitable for traditional tripods. In one embodiment, the float position adjuster or tail 104 has a plurality of adjustable positions. The user can bend the tail 104 as desired to achieve a desired position of the body 102, and thus a desired shooting direction 130 (FIGS. 6A-6C). Once achieved, the tail 104 remains in that desired position for the duration of the imaging.

As illustrated by FIG. 1 and FIG. 5, in an embodiment, the float position adjuster or tail 104 has a tapered shape formed of a plurality of segments 112. These segments 112 (numbered as segments s1-s20 in the illustrated embodiments (FIG. 5)) can act as a visual guide for reshaping the tail 104, allowing accuracy in shaping and positioning the tail 104. For example, by counting the segments 112, a user can determine a desired location for a forming a bend in the tail 104. For example, a substantially ninety degree bend at three segments 112 from the tail end 105 can correspond to a 30 degree shooting angle relative to the horizontal axis 107 of the holder 100 into the water, and a ninety degree bend at five segments 112 from the tail end 105 can correspond to a 40 degree shooting angle relative to the horizontal axis 107 into the water.

Referring to FIGS. 5 and 6A-6C, in an embodiment, the holder 100 floats on or in the water for imaging in a water environment. The holder 100 can be positioned for imaging at the water surface 132 for a boat or swimmer's perspective, partially above the water surface 132, partially below the water surface 132, or completely below the water surface 132. The position of the holder 100 can be controlled by positioning and shaping the tail 104. The tail 104 acts as a counterbalance, adjusting the shooting angle or shooting direction 130 of the imaging device 101 attached to the holder 100. As illustrated in FIG. 6A, when the tail 104 extends substantially straight from the back of the body 102, the face 103 of the holder 100 strikes the water surface 132 so as to position the shooting direction 130 horizontally across and substantially parallel to the plane of the water surface 132 along the horizontal axis 107 (FIG. 1). When the user bends and reshapes the tail 104, the holder 100 causes the imaging device to image at an angle relative to the horizontal axis 107 (FIG. 1). For example, as illustrated in FIG. 6B, when the tail 104 is bent downward in shape or position Y such that a portion of the tail 104 extends downward along an axis 134 extending perpendicular to the horizontal axis 107 (FIG. 1) and the shooting direction 130, the body 102 is positioned such that the shooting direction 130 extends at an upward angle (i.e., directed away from the water surface 132) relative to the water surface 132 so as to intersect with the plane of the water surface 132. In another example, as illustrated in FIG. 6C, when the user bends and reshapes the tail 104 upward in shape or position X such that a portion of the tail 104 extends upward along an axis 134 extending perpendicular to the horizontal axis 107 (FIG. 1) and the shooting direction 130, the body 102 is positioned such that the shooting direction 130 extends at a downward angle (i.e., into the water) relative to the water surface 132 so as to intersect with the plane of the water surface 132.

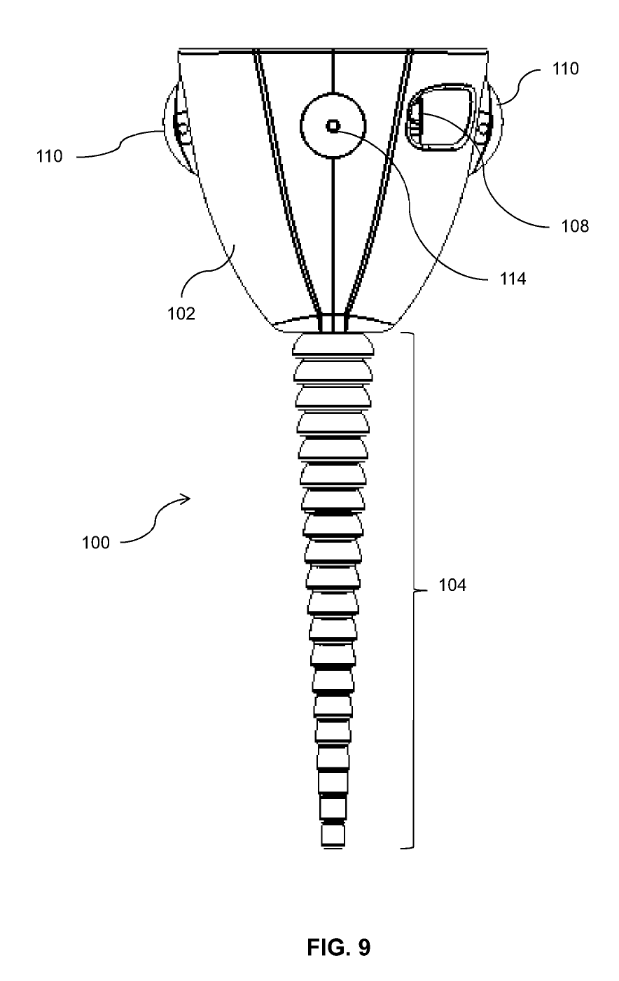

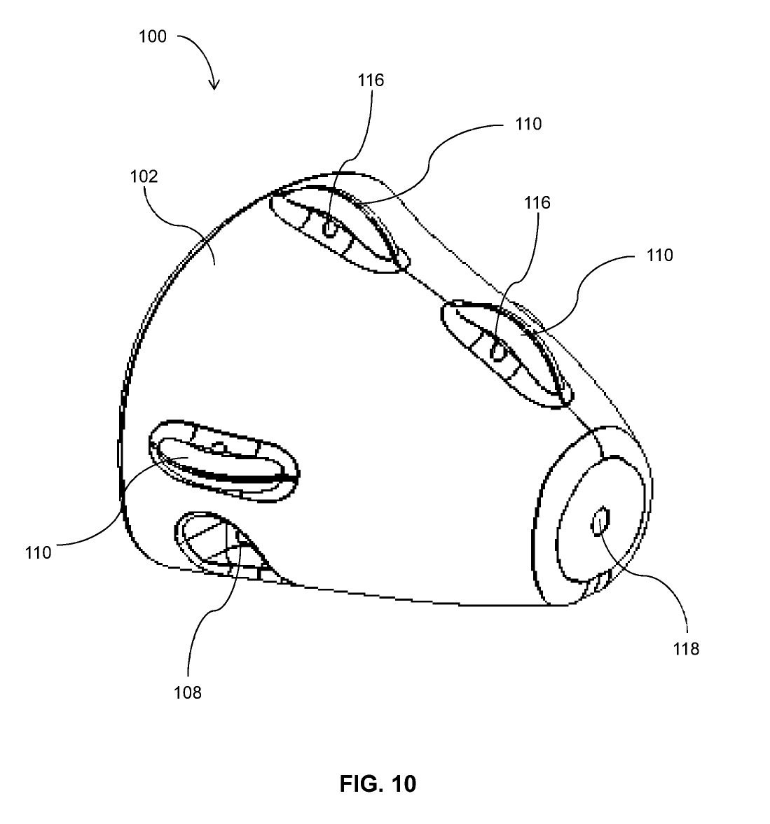

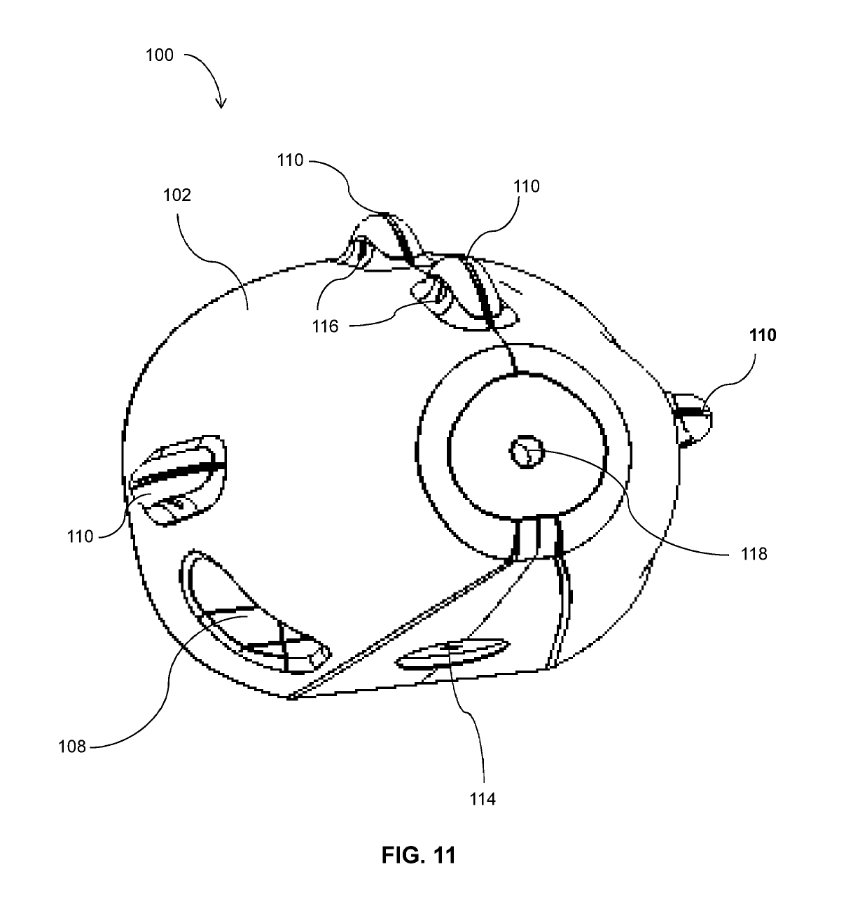

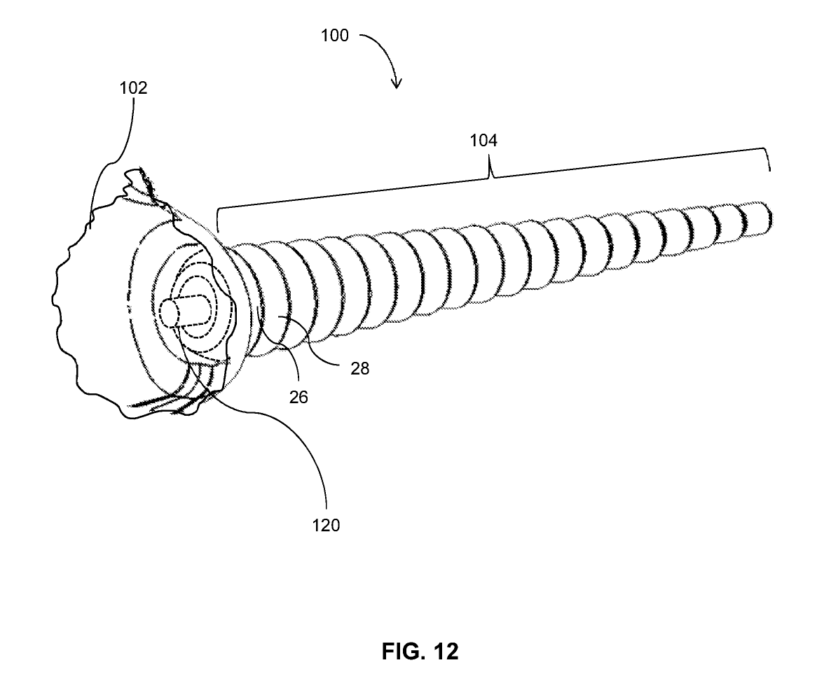

The degree of the angle between the shooting direction 130 and the plane of the water surface 132 depends on the shape of the tail 104 and its shape factors. The shape factors can include the location of the tail bend relative to the tail end 105 and the degree to which the tail 104 is bent (e.g., a thirty degree bend or a ninety degree bend). For example, the holder 100 can position the imaging device 101 to shoot into the water at an angle of up to 45 degrees relative to the horizontal axis 107. As illustrated by FIGS. 9-12, the float position adjuster or tail 104 is, in one embodiment, detachable from the body 102. In an embodiment, the body 102, without the tail 104, can be used an enclosure, protector or transporter for the imaging device 101. In another embodiment, tails having various designs such as differing shapes and/or weights, can be interchangeably coupled to the body 102. The body 102 has a tail recess 118 for receiving the tail 104. As illustrated by FIG. 11, the tail recess 118 can be formed to receive a tail coupler 120 (FIG. 12). The tail coupler 120 can be any suitable type of fastener. For example, the tail recess 118 can be a ¼-20 female mount for receiving a ¼-20 thread screw. In another embodiment, the tail 104 is configured to be removably attached to the body 102 through a snap-fit, screw-fit, or press-fit connection. In an embodiment, the first segment s1 of the tail 104 is non-pivotally coupled to the body 102 and the remaining segments, e.g., s2-s20, are pivotally movable relative to the respective adjacent segments.

Referring to FIG. 12-13, in an embodiment, the first tail segment 26 closest to the body 102 is non-pivotally or fixedly connected to the body 102. In another embodiment, the first tail segment 26 is connected to body 102 in a fashion to impede or prevent a pivot, swivel or rotation relative to the body 102. In such embodiment, the second tail 28 segment is pivotally, swivelly, rotatably, movably or bendably connected to the first tail segment 26 to enable tail shape changes described above. In an embodiment, the first tail segment 26 is fixedly connected to the screw, bold or shaft 120 which, in turn, is fixedly connected to the body 102. In another embodiment, the first tail segment 26 is integral with the body 102.

In an embodiment of the imaging device holder not illustrated, the body 102 is a housing or enclosure configured to entirely encase the imaging device 101. In this embodiment, the face entirely covers the imaging device 101, and the face includes a transparent section aligned with the lens of the imaging device 101. The body 102 defines an interior cavity configured to receive and house the imaging device 101. Also, the body 102 includes a door or panel which is movably coupled to the wall of the body 102. This enables the user to pivot or remove such panel, insert the imaging device, and then close the panel to seal-off the imaging device holder. In such embodiment, the image device holder has one or more environmental seals to prevent or minimize the entry of liquid and other fluid into the interior cavity. Accordingly, such image device holder can protect a non-waterproofed imaging device from water and liquids.

Additional embodiments include any one of the embodiments described above, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

The following is claimed:

1. An imaging device holder comprising:
a body defining a recess configured to at least partially receive an imaging device, the body comprising a buoyant characteristic; and
a tail coupled to the body, the tail comprising:
a first tail segment non-pivotally coupled to the body; and
a second tail segment coupled to the first tail segment, the second tail segment being movable relative to the first tail segment,
wherein a horizontal axis extends through the imaging device holder, and the horizontal axis is positionable relative to a plane of a liquid surface upon which the holder is placed, and
wherein the second tail segment is configured to be moved relative to the horizontal axis to aim a shooting direction of the imaging device.

2. The imaging device holder of claim 1, wherein the liquid surface comprises a water surface.

3. The imaging device holder of claim 2, wherein the second tail segment is configured to pivot upward relative to the horizontal axis to aim the shooting direction at a downward angle relative to the plane.

4. The imaging device holder of claim 2, wherein the second tail segment is configured to pivot downward relative to the horizontal axis to aim the shooting direction at an upward angle relative to the plane.

5. The imaging device holder of claim 1, wherein the body comprises a plurality of tabs extending from the body, each tab defined a hole, wherein the plurality of tabs comprises a lacing guide.

6. The imaging device holder of claim 1, wherein the tail comprises a core and a coating thereon, the coating comprising the first and second tail segments.

7. An imaging device holder comprising:
a body comprising an imaging device coupler and a buoyant characteristic; and
a tail coupled to the body, the tail configured to be changed from a first shape to a second shape in response to a force greater than a shape deformation force.

8. The imaging device holder of claim 7, wherein the tail is integral with the body.

9. The imaging device holder of claim 7, wherein the tail is fixedly connected to the body.

10. The imaging device holder of claim 7, wherein the tail is non-pivotally connected to the body.

11. The imaging device holder of claim 7, wherein:
the tail comprises a first tail segment non-pivotally coupled to the body and a second tail segment coupled to the first tail segment, the second tail segment being movable relative to the first tail segment;
a horizontal axis extends through the body;
the tail is configured to be changed in shape relative to the horizontal axis; and
the tail is configured to aim a shooting direction of the imaging device based on a position of the tail relative to the horizontal axis.

12. The imaging device holder of claim 7, wherein the tail comprises at least three tail segments.

13. The imaging device holder of claim 7, wherein the tail is coupled to the body by one of a screw fit and a press fit.

14. An imaging device holder comprising:
a body defining a recess configured to at least partially receive an imaging device, the body comprising a buoyant characteristic; and
a tail coupled to the body, the tail comprising:
a bendable core; and
a coating covering the core.

15. The imaging device holder of claim 14, wherein the coating is formed as a plurality of adjacent segments.

16. The imaging device holder of claim 15, wherein each segment is movable relative to adjacent segments to form a bend in the tail.

17. The imaging device holder of claim 16, wherein each segment is pivotally movable relative to the adjacent segments.

18. The imaging device holder of claim 14, wherein the tail is configured to position a shooting direction of the imaging device.

19. The imaging device holder of claim 18, wherein when the tail is positioned with an upward bend, the shooting direction extends downward relative to a horizontal axis.

20. The imaging device holder of claim 18, wherein when the tail is positioned with a downward bend, the shooting direction extends upward relative to a horizontal axis.
